(19) United States
(12) Patent Application Publication
(10) Pub. No.: US 2004/0249679 A1
(43) Pub. Date: Dec. 9, 2004

(54) Systems and methods for qualifying expected loss due to contingent destructive human activities

(75) Inventors: E. DeVere Henderson, Arlington, VA (US); Timothy P. Coffin, Springfield, VA (US)

Correspondence Address: OLIFF & BERRIDGE, PLC, P.O. BOX 19928, ALEXANDRIA, VA, 22320, US

(73) Assignee: RISK ASSESSMENT SOLUTIONS, LLC, Arlington, VA

(21) Appl. No.: 10/694,081

(22) Filed: Oct. 28, 2003

Related U.S. Application Data
(60) Provisional application No. 60/474,931, filed on Jun. 3, 2003.

(51) Int. Cl. G06F 17/60; G06G 7/48

(52) U.S. Cl. 705/4; 703/6

(57) ABSTRACT

Systems and methods allow a user to specify states of influence variables with information from an expert system to perform assessment regarding probable damages caused by a terrorist attack to a property to which insurance premiums are to be established. The expert system provides information based on knowledge of terrorists, including their goals, methods, organization and financial structure. The systems and methods use quality information to establish a relevant set of variables and to subjectively define the probabilistic influences of the defined variables on the likelihood of attack and levels of damage.

This application claims priority under 35 U.S.C. §119 of U.S. Provisional Application No. 60/474,931, filed Jun. 3, 2003, which is incorporated herein by reference in its entirety.

### BACKGROUND OF THE INVENTION

1. Field of Invention

This invention relates to systems and methods for qualifying expected loss due to contingent destructive human activities, such as terrorism and criminal activity.

2. Description of Related Art

After the terrorist actions of Sep. 11, 2001, prudent businesses need to purchase terrorism insurance and prudent insurers need to provide it. However, without the underwriting tools that can evaluate and assess terrorist risk, setting differential premium rates for terrorism insurance is impossible. Such tools are not currently available in the industry. Yet, such tools are essential if private insurers and re-insurers are to provide terrorist insurance coverage in a manner that generates the financial incentives for owners to invest and fund significant reduction in the vulnerability of the buildings in which much of America works.

Currently, there is no known process that provides a comprehensive systematic approach to terrorism risk evaluation. Conventional processes attempt to use natural disaster models to model terrorist risk based on the adaptation of hurricane and earthquake models and frequency data. But these approaches do not provide the array of underwriting tools required to give insurers, self-insurers and regulators a credible, real-time, best-practices-based approach to identifying, quantifying, and mitigating risk exposure. Furthermore, these approaches do not provide the basis for property owners to undertake risk mitigation initiatives such as education and training that are tied directly to the likelihood and nature of the terrorist threat.

### SUMMARY OF THE INVENTION

One of the recurring issues associated with establishing terrorist insurance premiums is the problem of predicting the likelihood of attack and the likely consequences. In contrast to natural disasters, accidents and other phenomena where there is historical data, very little data exists on the frequency with which a terrorist attack will occur. Furthermore, in view of the dynamic manner in which the goals, objectives and capabilities of various threat entities change, it is doubtful that a meaningful database will evolve that will support estimating the likelihood of attack based on historical data. What is required is a threat assessment process that supports identifying the factors that influence the decision-making of terrorists.

“Model for Adaptive Decision-Making Behavior of Distributed Hierarchical Teams Under High Temporal Workload,” by Eldon DeVere Henderson, George Mason University (doctoral dissertation), 1999, (Henderson) proposes a Cognitive Engineering Process (CEP). The Cognitive Engineering Process is a circular iterative process to create hierarchical decision-making models of terrorist behavior that allow assessment of risk of terrorist attack.

This invention provides systems and method for establishing differential premiums for terrorist insurance.

This invention separately provides systems and method for establishing differential premiums for terrorist insurance that incorporate results of on-site building damage assessments and damage level analysis models.

This invention separately provides systems and method for establishing differential premiums for terrorist insurance that incorporate subjective probability distributions.

This invention separately provides systems and method for establishing differential premiums for terrorist insurance using the probability distributions.

This invention separately provides systems and method for using the probability distributions by threat domain experts based on factors that are deemed by the experts to influence the probability of occurrence of attack against a property to be insured.

This invention separately provides systems and method for determining the factors that are deemed by the experts to influence the probability of occurrence of attack against the property to be insured based on knowledge of terrorists.

This invention separately provides systems and method for determining the factors that are deemed by the experts to influence the probability of occurrence of attack against the property to be insured based on Bayesian networks.

Various exemplary embodiments of the systems and methods of this invention allow a user to specify states of influence variables with information from an expert system to perform assessment regarding probable damages caused by a terrorist attack to a property to which insurance premiums are to be established. In various exemplary embodiments, the expert system provides information based on knowledge of terrorists, including their goals, methods, organization and financial structure.

In various exemplary embodiments, the systems and methods according to this invention use quality information to establish a relevant set of variables and to subjectively define the probabilistic influences of the defined variables on the likelihood of attack and levels of damage, rather than attempting to extrapolate likelihood from extant natural disaster models.

In various exemplary embodiments, the systems and methods of this invention combine the results of on-site building damage assessments and damage level analysis models with subjective probability distributions. In various exemplary embodiments, the subjective probability distributions are developed by threat domain experts and/or expert systems, and are based on the factors that are determined by the experts to influence the probability of occurrence of attack against a property to which insurance premiums are to be established. In various exemplary embodiments, the systems and methods of this invention yield mathematically rigorous quantified estimates of gross expected loss. These estimates can be used as a foundation for establishing differential premiums for terrorist insurance.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the systems and methods of this invention will be described in detail, with reference to the following figures, wherein:

FIG. 1 is a flowchart outlining an exemplary embodiment of a method for performing risk analysis according to this invention;

FIG. 2 is a diagram illustrating one exemplary embodiment of a conditional linkages diagram according to this invention.;

FIG. 3 illustrates a first exemplary embodiment of a graphical user interface according to the present invention;

FIG. 4 illustrates a second exemplary embodiment of a graphical user interface according to the present invention;

FIG. 5 illustrates a third exemplary embodiment of a graphical user interface according to the present invention;

FIG. 6 illustrates a fourth exemplary embodiment of a graphical user interface according to the present invention; and

FIG. 7 is a functional block diagram of one exemplary embodiment of a risk assessment system according to this invention.

### DETAILED DESCRIPTION OF EXEMPLARY EMBODIMENTS

Various exemplary embodiments of the systems and methods according to this invention provide risk assessment and related analysis. In various exemplary embodiments, a terrorist organization, such as, for example, a Columbian terrorist group, is considered to have goals, organizational infrastructure, financial strength and weapons that are different from those of some other terrorists organizations, such as, for example, the Al Queda terrorist group. In various exemplary embodiments, an expert system may indicate an attack by the first terrorist organization, i.e., the Columbian terrorist group, is more likely to be a bombing attack in a city that is targeted by drug dealers, such as Miami, and that an attack by the second terrorist organization, i.e., the Al Queda terrorist group, is likely to be a nuclear attack at a political center, such as Washington, D.C. In various exemplary embodiments, the risk assessment may indicate the likelihood for a building to be attacked and/or the associated damaged based on the construction characteristics, the security level and the tenants of the building. In various exemplary embodiments, the risk assessment and the related information are used in estimating terrorism insurance premiums.

In various exemplary embodiments, the method for analyzing and assessing risks includes a cognitive engineering process that considers one or more of: 1) determining one or more functional requirements prescribed by a decision-making team's goals or an organizational task; 2) formulating a generic task hierarchy of the subtasks of the organization task that must be performed; 3) defining one or more measures of performance of the subtasks; 4) defining the linkages among the subtasks; 5) formulating one or more hypotheses concerning the influence of the linkages; 6) defining and executing an empirical experimental methodology to test the hypotheses; and 7) applying the experimental results to implement changes at some level in the task hierarchy. A detailed description of the cognitive engineering process is provided in Henderson, which is incorporated herein by reference in its entirety.

In various exemplary embodiments of the systems and methods according to this invention, the organizational task is to establish reasonable insurance premiums for insuring against damage caused by contingent destructive human activities, such as terrorism or crime. In various exemplary embodiments, the analysis is performed to determine a risk factor R associated with an entity that is to be insured. In various exemplary embodiments, the risk factor R is a function of a threat factor T to the entity, a vulnerability factor V of the entity to the threat, and a consequence factor C if an attack against the entity occurs. This relationship can be expressed mathematically as:

R=f(T, V, C). (1)

In various exemplary embodiments, the risk relationship expressed in Eq. (1) is assumed to be axiomatic.

In various exemplary embodiments, analyzing or assessing the risk includes determining the factors, or random variables, that influence the level or likelihood, which is itself a random variable of the terrorist threat of attack against the entity and the vulnerabilities of the entity to damage, that is, the likely damage level, which again is itself a random variable by various attack mechanisms. In various exemplary embodiments, the entity is a building. In various other exemplary embodiments, the entity is a static structure, such as a bridge or a tunnel. In various other exemplary embodiments, the entity is a critical facility, such as a power plant.

In various exemplary embodiments, analyzing or assessing the risk includes one or more of forming a generic hierarchy of the random variables that have been defined to influence the likelihood of attack and likely damage levels; defining the states that can be taken by the random variables; defining the conditional linkages or influences among the random variables; forming one or more hypotheses concerning the level of influence the random variables have on each other, including the likelihood of attack and the likely damage levels; creating a model that accurately reflects the risk to the entity based on the likelihood of attack, the likely damage levels, and the replacement cost of the entity; validating and evaluating model risk quantification results; and collecting any desired or necessary additional data that can be used to implement changes in the defined set of the random variables, their states, and their conditional linkages.

In various exemplary embodiments, the risk factor R is expressed as a gross expected loss. Similarly, the threat factor T is expressed as a probability of attack. In contrast, the vulnerability factor V is expressed as a damage factor, which is the percent damage to an entity, such as a building. The consequence factor C is expressed as a replacement cost of the entity. In various exemplary embodiments, the variables that influence the probability of attack are determined by a domain expert or a set of one or more domain experts. In various other exemplary embodiments, the variables that influence the probability of attack are determined using an expert system. The set of one or more domain experts is familiar with what motivates and enables terrorists to attack, under what conditions terrorist will attack and with what weapons. The set of more or more domain experts also understands how different types of structures and defenses will be affected by certain types of attack mechanisms. In various other exemplary embodiments, the variables that influence the probability of attack are determined using an expert system. In such exemplary embodiments, the expert system is an automated system that includes trained data that replicates the experience and judgment of the domain experts. The trained data is updated with current information related to loss assessment, such as information on new terrorist threats and change of characteristics of an insured building.

In various exemplary embodiments, the set of one or more domain experts, or the expert system, recognizes that not all terrorist organizations have the same goals, same organizational infrastructure, the same financial strength or the same set of available weapons. Therefore, one of the key variables that influences the probability of attack is the terrorist group under discussion. Similarly, the vulnerability of an entity is influenced by its construction, the particular weapon or weapons used to attack that entity and the nature of the defenses available to that entity. In various exemplary embodiments, the set of one or more domain experts, or the expert system, determines the variables that influence the threat and vulnerability based on one or more of building construction, building location, building tenants, weapons used to attack, delivery methods of attacks, attack mode, terrorist group goals, terrorist group identity, damage level, and probability of attack.

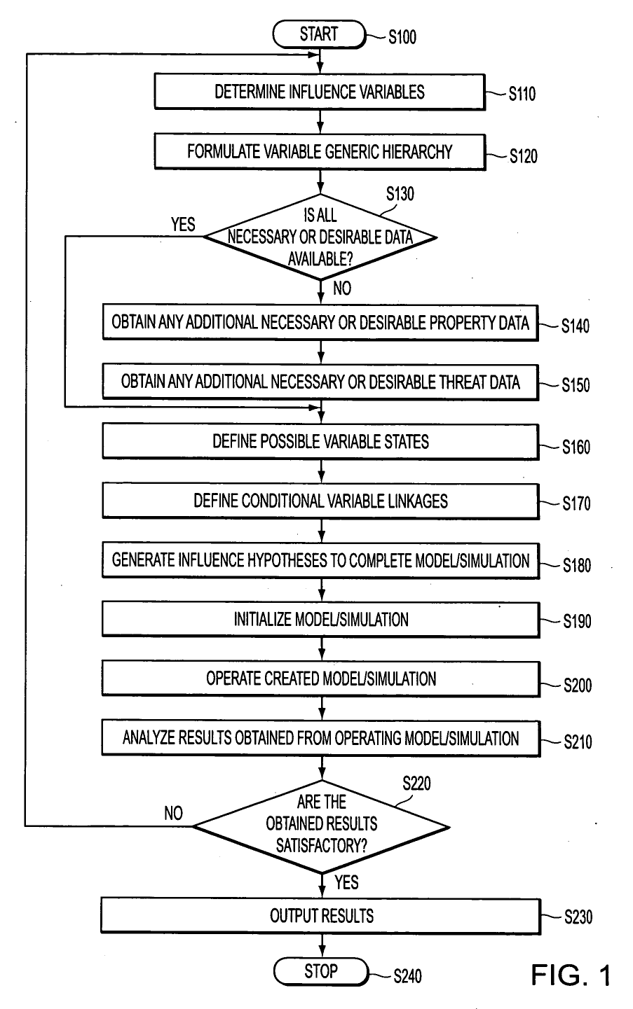

FIG. 1 is a flowchart outlining an exemplary embodiment of a method for analyzing or assessing risk according to this invention. As shown in FIG. 1, beginning in step S100, operation of the method continues to step S110, where one or more influence variables are determined. Next, in step S120, a generic variable hierarchy is formulated. In various exemplary embodiments, the generic variable hierarchy is formulated based on the influence variables determined in step S110. In various other exemplary embodiments, the generic variable hierarchy is formulated in the absence of robust data on the influence variables that are believed to influence risk. Then, in step S130, a determination is made whether all necessary or desirable data is available. If all necessary or desirable data is available, operation jumps to step S160. Otherwise, if not all necessary or desirable data is available, operation continues to step S140.

In step S140, additional necessary or desirable property data, if any, is obtained. Next, in step S150, additional necessary or desirable threat data, if any, is obtained. It should be appreciated that either of steps S140 or S150 can be skipped if it is data only on the other of steps S140 or S150 that is needed or desired. Then, in step S160, possible variable states are defined for each influence variable. Operation then continues to step S170.

In step S170, conditional linkages among the influence variables are defined. Next, in step S180, the set of one or more domain experts and/or expert system generates one or more hypotheses to complete the model or simulation. Then, in step S190, the model created in steps S110-S180 to explore the effects of the influences is initialized. Operation then continues to step S200.

In step S200, the model initialized is operated to determine the probability when one of the contingent states occurs. That is, a user may specify, based on some new information, that a particular state of one of the random variables in fact has occurred. Then, in step S210, the results obtained from the model when this state occurs are analyzed. Next, in step S220, a determination is made whether the results of the model are satisfactory. If the results of the model are not satisfactory, operation of the method jumps back to step S110. Otherwise, if the results of the model are satisfactory, operation of the method continues to step S230, where the results are output. Then, in step S240, operation of the method ends.

It should be appreciated that, when operation returns to step S110, any one or more of steps S110-S190 can be repeated. However, not all of steps S110-S180 have to be repeated. Thus, for example, steps S170 and S180 may be repeated, while steps S110-S160 are not. However, in general, steps S200-S220 will be repeated during each iteration.

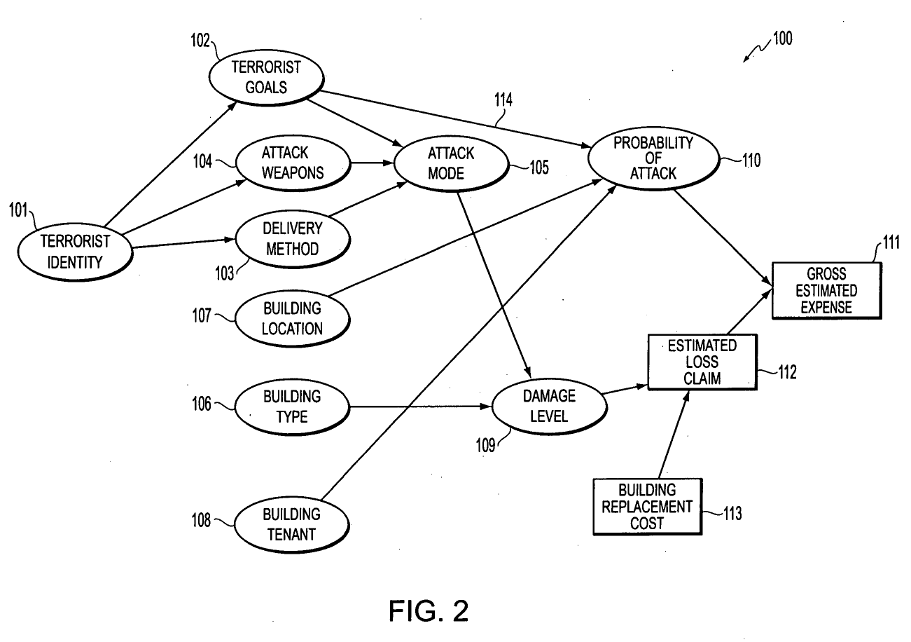

In various exemplary embodiments, in step S120, the set of one or more domain experts and/or the expert system formulates the generic variable hierarchy by postulating and modeling the influencing relationships, or dependencies, that exist among the influence variables and determining how to weight the strength of the influence among the influence variables. In various exemplary embodiments, the generic variable hierarchy is formulated by first formulating a generic hierarchy that is believed to replicate the general flow of causality or influence among the influence variables. In various exemplary embodiments, the variables are expressed as chance nodes in a Bayesian diagram. In such exemplary embodiments, the Bayesian diagram is arranged in an order that reflects parent and child node orientation, consistent with formulating the generic variable hierarchy, as discussed below in greater detail in connection with FIG. 2.

In various exemplary embodiments, in step S160, each variable is considered to be a random variable that exists in a discrete state. The states of each variable can be separately defined. In various exemplary embodiments, the states are defined by the set of one or more domain experts and/or the expert system. In various other exemplary embodiments, the states are defined by a user. In such exemplary embodiments, the user refers to expert domain knowledge that relates to each of the variables. For example, identifying the relevant states of the variable “Terrorist Identity” requires the set of one or more domain experts and/or the expert system to bind the set of states to a manageable number of organizations that represent feasible threats to the entity of concern. An exemplary set of states for a set of influence variables shown in FIG. 2 is provided in Table 1 and will be discussed below in greater detail in connection with FIG. 2.

TABLE 1

| Random Variable | State 1 | State 2 | State 3 |
|---|---|---|---|
| Building Type | Type 1 | Type 2 | |
| Building Location | Major Suburban | Major Suburban | Major |
| | Area 1 | Area 2 | Suburban Area |
| | | | 3 |
| Building Tenant | Agency X | Agency Y | |
| Attack Weapons | Blast | Fire | |
| Delivery Method | Truck | Aircraft | |
| Attack Mode | Blast/Truck | Fire/Airplane | Fire/Truck |
| Terrorist Identity | Group A | Group B | |
| Terrorist Goals | Create Fear | Create Damage | |
| Damage Level | Less than 50% | 50% or More | |
| Probability of | Less that 50% | 50% or More | |
| Attack | | | |

In various exemplary embodiments, in step S70, the set of one or more domain experts and/or the expert system determines if the state of an influence variable depends on the condition, or state, of some other influence variable. The set of one or more domain experts and/or the expert system determines whether one influence variable has an influence on the state of another influence variable. For example, the set of one or more domain experts and/or the expert system determines how the identity of a particular group influences the weapons that are likely to be used, or influences the location of a building that is likely to be attacked. The set of one or more domain experts and/or the expert system evaluates the influence variables in the generic variable hierarchy and defines the conditional linkages among the influence variables.

In various exemplary embodiments, in step S180, the set of one or more domain experts and/or expert system generates the one or more hypotheses based on the strength of the linkage, that is, the level of dependence or influence of the state of an influence variable upon the state of another influence variable. In various exemplary embodiments which use the set of one or more domain experts, in the absence of extensive data, the domain experts use the best information available, along with their experience and knowledge of the domain, to make subjective estimates as to what the likelihood of a state or event will be. The set of one or more domain experts and/or the expert system develops subjective probability tables that define how the state of one influence variable influences the state of another influence variable.

In various exemplary embodiments of the systems and methods of this invention, Bayesian conditional probability theory is used to express the conditional likelihood of a set of multiple variables. In various exemplary embodiments, probability tables are created to associate the conditional dependencies among the influence variables and to propagate the dependencies through a conditional linkage diagram, as will be discussed below in greater detail in connection of FIG. 2.

In various exemplary embodiments, standard software packages can be used to enable the set of one or more domain experts and/or the expert system to create a conditional linkages diagram, commonly known as an influence diagram. The standard software packages then use the influence diagram to create template probability tables that the set of one or more domain experts and/or the expert system can complete to define the conditional probability relationships among the influence variables. When the probability distributions are complete, the influence diagram becomes a Bayesian network that is capable of propagating belief levels. In various exemplary embodiments of the systems and methods of this invention, the Hugin® software package is used to create the conditional linkage diagrams. Operation of the method then continues to step S190.

In various exemplary embodiments, in step S190, using the Bayesian probability theory as implemented in the Hugin® software, the model is automatically created in the course of performing steps S110-S180 discussed above.

FIG. 2 is a diagram illustrating one exemplary embodiment of a conditional linkages diagram 100 according to this invention. As shown in FIG. 2, the conditional linkage diagram 100 includes a terrorist identity node 101, a terrorist goals node 102, a delivery method node 103, an attack weapons node 104, an attack mode node 105, a building type node 106, a building location node 107, a building tenant node 108, a damage level node 109, and a probability of attack node 110. These nodes are also listed in Table 1, as discussed above.

In various exemplary embodiments, the terrorist identity node 101 indicates a set of particular terrorist groups, such as domestic terrorist groups and/or foreign terrorist groups with each state of the terrorist identity node 101 representing a different group. It should be appreciated that a vandalism individual or group or other criminal entity that is likely to commit a destructive act may be classified as a terrorist group.

In various exemplary embodiments, each state of the terrorist goals node 102 indicates a different goal of the terrorist groups, such as creating fear and/or creating damages. Each state of the delivery method node 103 indicates a different method that the terrorist group can use to deliver an attack, such as using a truck and/or an aircraft. Each state of the attack weapons node 104 indicates a different specific weapon that is likely to be employed, such as a blast, a fire and a chemical agent. Each state of the attack mode node 105 indicates a different mode that can be used by the terrorist group to carry out an attack, such as using a truck to create a blast and using an airplane to create a fire.

In various exemplary embodiments, the states of the building type node 106 indicate the different type of entity that is to be insured, such as an office building, a residence complex, a bridge, a tunnel, a highway overpass and a power plant. In various other exemplary embodiments, the states of the building type node 106 additionally or alternatively indicate building information, such as building blue prints, construction specifications, construction history and building defense mechanisms, such as security measures and fire-proof characteristics. The states of the building location node 107 indicate the type of location of the entity, such as major suburban, urban, rural, beach and mountain area. The states of the building tenant node 108 indicate tenant information of the entity that is to be insured. In various exemplary embodiments, the tenant information can include, for example, whether an important political figure resides in a residence complex that is to be insured, whether an important businessman has an office in an office building and whether a popular singer that is a target of a vandalism group frequents a beach resort.

In various exemplary embodiments, the states of the damage level node 109 indicate the different seriousness of the destructive human activities. The states of the probability of attack node 110 indicate the different likelihoods that an attack will occur.

As shown in FIG. 2, the nodes 101-110 are arranged based on the generic variable hierarchy. The orientation of the hierarchy is such that the parent nodes are located toward the left hand side of the conditional linkages diagram 100 relative to their child node and the child nodes are located toward the right hand side of the conditional linkages diagram 100 relative to their parent nodes. The arrows 114 indicated the conditional linkages between the nodes 101-110. For example, an arrow 114 originates from the terrorist goals node 102 towards the probability of attack node 110, indicating that the values of the states of the terrorist goals node 102 have an influence upon the values of the states of the probability of attack node 110. In various exemplary embodiments, the nodes are organized based on a Bayesian network.

As shown in FIG. 2, when assessing an insurance loss risk, the conditional linkages diagram 100 also includes a gross estimated expense node 111, an estimated loss claim node 112 and a building replacement cost node 113. In various exemplary embodiments, the gross estimated expense node 111 indicates a risk assessment associated with insurance premium calculations. The estimated loss claim node 112 indicates a damage level, such as a percentage of the value of the building. The building replacement cost node 113 indicates a total value of the building.

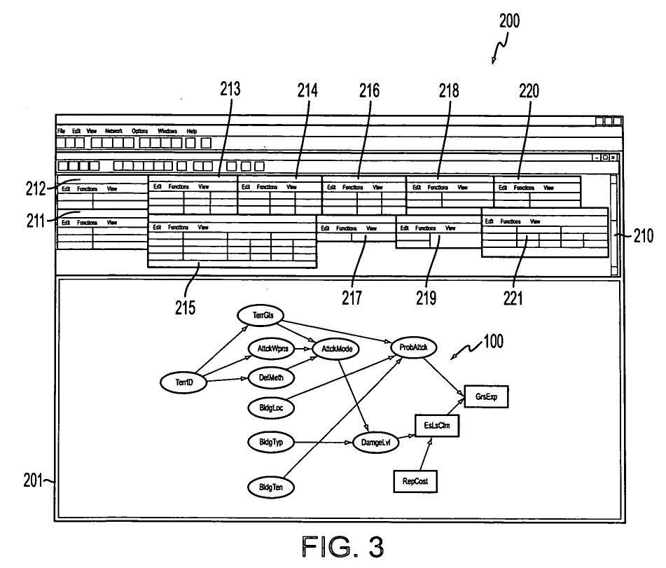

FIG. 3 illustrates a first exemplary embodiment of a graphical user interface according to this invention. In various exemplary embodiments, the user interface 200 of FIG. 3 is used to display the creation and initialization of the model/simulation discussed above in connection with step S190 of FIG. 1. As shown in FIG. 3, the interface 200 comprises a display portion 201 and a control portion 210. The display portion 201 displays the conditional linkages diagram 100 and its nodes. The control portion 210 includes a plurality of graphical user interface elements or widgets.

In various exemplary embodiments, the graphical user interface elements or widgets are pull-down menus. In various other exemplary embodiments, the graphical user interface elements or widgets are fields that the user can use to input symbols and/or numerals. In various other exemplary embodiments, the graphical user interface elements or widgets are interactive tables. In various other exemplary embodiments, the graphical user interface elements or widgets are a combination of pull-down menus, tables and fields.

In the exemplary embodiment shown in FIG. 3, the control portion 210 includes a building location portion 211, a terrorist identification portion 212, a terrorist goals portion 213, an attack weapon portion 214, a damage level portion 215, a delivery method portion 216, a building replacement cost portion 217, a building type portion 218, an estimated loss claim portion 219, a building tenant portion 220, and a gross estimated expense portion 201. Of course, depending on the type of risk, one or more of these portions may be omitted, and/or other appropriate portions added.

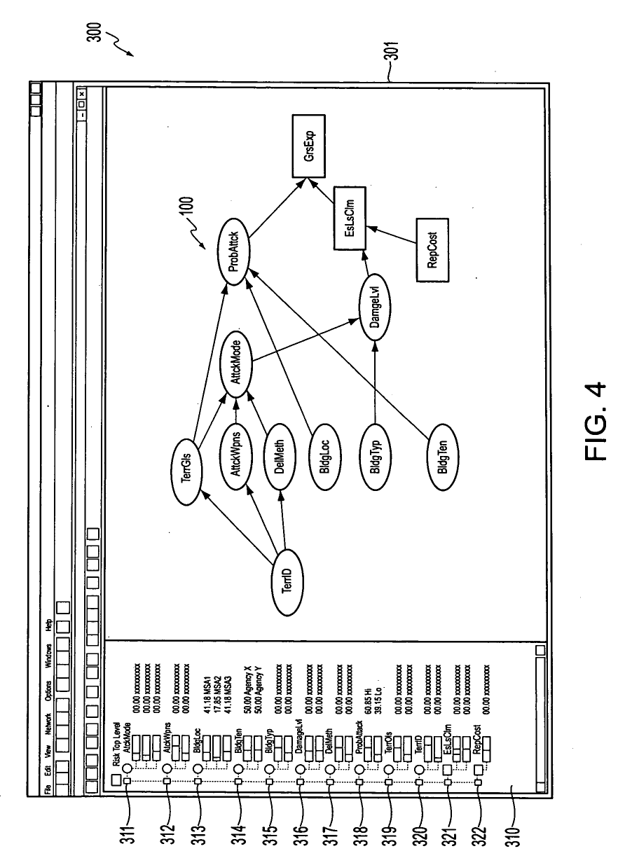

FIG. 4 illustrates a second exemplary embodiment of a graphical user interface according to this invention. In various exemplary embodiments, the user interface 300 of FIG. 4 is used to display the operation of the model/simulation discussed above in connection with step S200 of FIG. 1, after the model creation and initialization with the user interface 100 of FIG. 3. As shown in FIG. 4, the graphical user interface 300 includes a display portion 301 and an operation portion 310. The display portion 301 displays the conditional linkages diagram 100 and its nodes. The operation portion 310 includes a plurality of graphical user interface elements or widgets.

In various exemplary embodiments, the graphical user interface elements or widgets are pull-down menus. In various other exemplary embodiments, the graphical user interface elements or widgets are fields that the user can use to input symbols and/or numerals. In various other exemplary embodiments, the graphical user interface elements or widgets are a combination of pull-down menus and fields. In various exemplary embodiments, the graphical user interface elements or widgets are organized in a tree configuration.

In the exemplary embodiment of the graphical user interface 300 shown in FIG. 4, the operation portion 310 includes an attack mode menu item 311, an attack weapon menu item 312, a building location menu item 313, a building tenant menu item 314, a building type menu item 315, a damage level menu item 316, a delivery method menu item 317, a probability of attack menu item 318, a terrorist goals menu item 319, a terrorist identification menu item 320, an estimated loss claim menu item 321, and building replacement cost menu item 322. Of course, depending on the type of risk, one or more of these items may be omitted, and/or other appropriate items added.

In various exemplary embodiments, one or more of the menu item in the operation portion 310 show the initialized values. In various exemplary embodiments, the distributions for the parent nodes, those that have at least one output but no input, are the same as the prior probabilities entered into the corresponding menus items. The values of the child nodes reflect the fact that the models or algorithms that implement Bayesian probability theory propagate beliefs in both directions from the nodes in the network. In the particular example shown in FIG. 4, based on the probabilities entered, the probability of a terrorist attack being high is 0.6085, or about 61%, and the probability of the terrorist attack being low is about 39%.

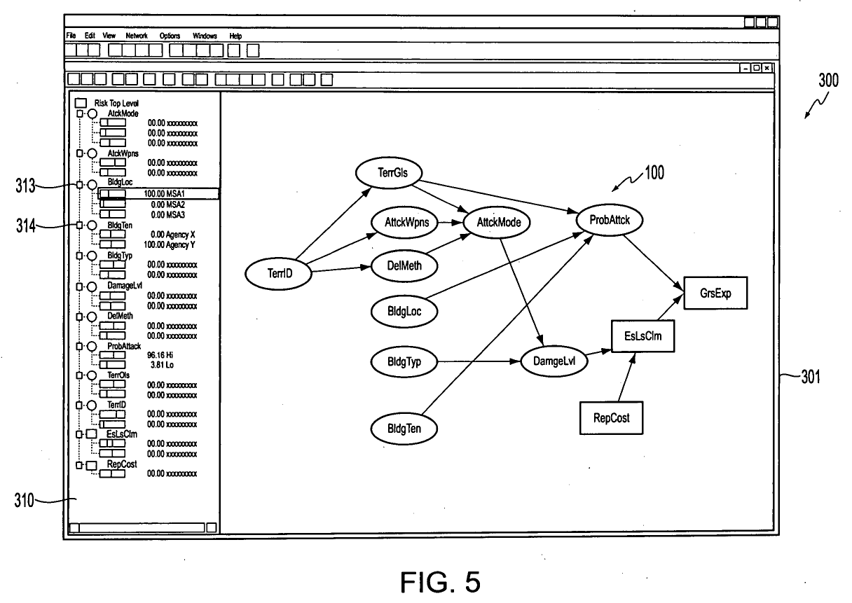

In various exemplary embodiments, the parameters of the model/simulation can be modified and/or updated. FIG. 5 shows the graphical user interface 300 shown in FIG. 4 after the user has changed the values of one or more of the states of one or more of the influence variables. In particular, FIG. 5 represents how the values of the states change based on new information that one or more of the random variables have in fact occurred. As shown in FIG. 5, the user specifies that it is known that an entity is in Major Suburban Area 1 and that the building is occupied by Agency Y. Thus, the percentages or probabilities for the state “Major Suburban Area 1” of the building location menu item 313 and the state “Agency Y” of the building tenant menu item 314, respectively, are updated to 100%. Instantiating the states of the Building Location and Building Tenant influence variables to those two states respectively, the probabilities are propagated throughout the network and the values of the probability distribution, as shown in FIG. 5, are altered. Based on these updates, the probability of attack becomes 0.9619, or about 96%.

In various exemplary embodiments, the results shown in FIGS. 4 and 5 are reviewed by the one or more domain experts and/or an expert system to assess whether the results are logical and consistent with the information and the experts domain knowledge. In such exemplary embodiments, the one or more domain experts and/or the expert system might believe that the probability of attack in Major Suburban Area 1 against a building occupied by Agency Y is excessively high. This would cause the experts to review the model and reevaluate the prior and conditional probability distributions, then re-run the model, as discussed above in connection with step S220 of FIG. 1.

In various exemplary embodiments, if the results shown in FIGS. 4 and 5 are, after being reviewed by the one or more domain experts and/or the expert system, considered logical and consistent with the available information and the experts' domain knowledge, the results are output to, for example, a terrorist risk domain, such as, for example, a terrorist insurance risk domain to provide building ratings, threat ratings, and other parameters that can be used as the basis for differential terrorist insurance premiums. In various exemplary embodiments, the determination of the parameters takes into account both the assessed vulnerability of each of the entities, as well as the estimated terrorist threat, including arson, explosions, and/or chemical, biological and/or nuclear attacks. The determination is applied to each of these types of threats, using appropriate vulnerability and threat input information.

In various exemplary embodiments, where the risk to be assessed is, for example, insurance loss risk, each insured entity is awarded a damage rating or damage factor, which is a number representing an estimated percentage of loss that the entity would experience given that the entity is subjected to a terrorist attack. This is represented by:

Damage Factor=Estimated Loss Claim/Building Replacement Cost. (2)

In various exemplary embodiments, the damage factors are determined for each type of threats as a percentage of loss.

In various exemplary embodiments of the systems and methods according to this invention, where the risk to be assessed is, for example, insurance loss risk, a direct attack gross expected loss (G_{D}) differs from an estimated loss claim due to indirect attack G_{I}. In various exemplary embodiments, the direct attack gross expected loss (G_{D}) of an entity from a direct attack is determined to be the product of the probability of occurrence, P(O), of an attack, and the estimated loss claim.

In various exemplary embodiments, the direct attack gross expected loss G_{D} can be expressed as:

GD=P(O)×LE (3)

where:

P(O) is the probability of a successful attack on a property;

C is the building replacement cost;

D_{F} is the damage factor; and

L_{E} is the expected loss claim.

In various exemplary embodiments, the indirect gross expected loss G_{I} refers to the collateral damage to one entity that occurs due to an attack against a nearby entity. The indirect gross expected loss G_{I} is determined separately, as discussed in greater detail below, and is then combined with direct attack gross expected loss G_{D} to determine the total gross expected loss G_{T}.

In various exemplary embodiments, the direct attack gross expected loss G_{D} from a particular terrorist attack against an entity is determined based on the type and detailed description of attack, estimates of the likelihood of that type of attack occurring, and that type of attack chance of success, as discussed above. The level of damage to the entity depends upon the construction, defenses, and other characteristics of that entity that can mitigate or exacerbate the effects of attacks by fire or explosion, and/or biological, chemical, and/or nuclear blast and/or radiation attacks.

In various exemplary embodiments, the set of one or more domain experts and/or an expert system analyze different representative attacks against different types of entities. The results of the analysis, with some adaptation and refinement, are applied to an attack against the particular entity whose risk is being assessed. The descriptions of these attacks provide users the information they need for an accurate risk assessment. In various exemplary embodiments, the descriptions include the type and magnitude of the weapon employed, its placement and how it is delivered.

It should be appreciated that such descriptions are significantly different from simply stating what effects the building would experience—such as 500 psi overpressure in the case of an explosive attack. There are several reasons for avoiding that simple approach. First, it matters where the overpressure is experienced in calculating the likely damage produced. Second, it would not be possible to assess the probability of the attack being successful if the method by which it was conducted is not specified. Finally, the simple approach does not use the knowledge of terrorist methods of operation and available resources.

In various exemplary embodiments, each of the attacks designed by the set of one or more domain experts and/or the expert system is not considered equally likely to occur. Estimates of the terrorists' probability of using specific attack modes are determined based upon the knowledge of the set of one or more domain experts and/or the expert system of the terrorists' usual method of operations; the materials, finds, and infrastructure available to the terrorists; the terrorist's capability to mount particular types of attacks; the terrorist's willingness to take risks and sustain losses; and the terrorist's likely knowledge of the details of an entity's design. The output of this analysis provides an estimate of the probability, P(M=m) for m=1,2, . . . , n of each planned attack mode being the attack mode that is actually employed.

In various exemplary embodiments, the probability of the attack being executed by a particular hostile agent using a specific attack mode, P(O), is determined for every attack mode that is planned against a particular entity. In addition to the details of the attack mode, this assessment is based upon the active and passive defenses possessed by the entity, as well as the assessment by the set of one or more domain experts and/or the expert system of the knowledge the terrorists would likely have of these defenses. These probabilities could be quite different in magnitude. For example, while the probability of terrorists successfully driving a panel truck with 1,000 pounds of high explosive into a building's underground garage might be low, the probability of one terrorist carrying a suitcase bomb through the main entrance might be quite high.

In various exemplary embodiments, the risk to each property is assessed based on the results of an on-site inspection of the entity to identify strengths and weaknesses of a property and its defenses. The characteristics of the entity are assessed using a set of checklists. The information from the assessment is entered into computer-based damage assessment models to predict the effects on the entity using various attack modes. It should appreciated that the on-site inspection may not be required when using an expert system that inspects the strengths and weaknesses of the building by processing information of the building, such as blueprints and construction history.

In various exemplary embodiments, information from multiple disparate sources, most of which involve intrinsic and irreducible uncertainties, is combined for assessing the threat of a terrorist attack. A framework of Bayesian networks offers a compact, intuitive, and efficient graphical representation of the dependence relations among elements of a problem that allows for these uncertainties, organizing the known information into a structure that represents the dependency of variables and how the variables are likely to affect one another.

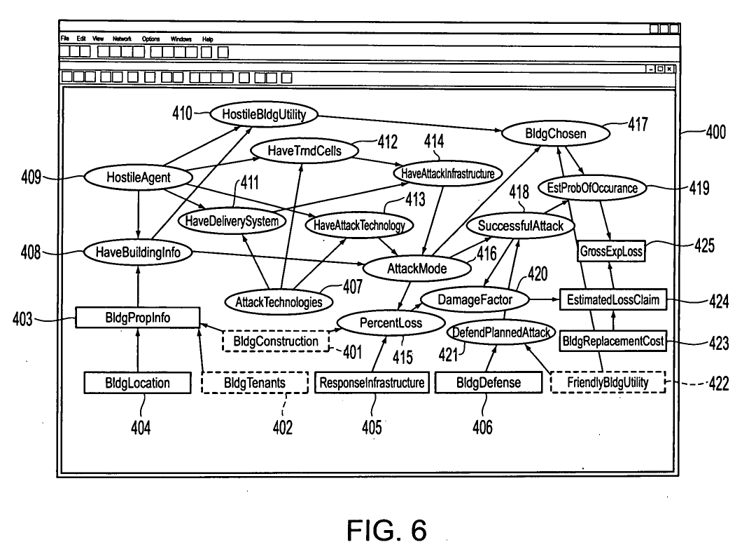

FIG. 6 illustrates a fourth exemplary embodiment of a graphical user interface according to this invention. As shown in FIG. 6, the graphical user interface 400 illustrates properties of the problem in an intuitive way, which makes it easy for non-experts of Bayesian networks to understand and help build this kind of knowledge representation. It is possible to use both background knowledge and knowledge stored in databases when constructing Bayesian networks.

As shown in FIG. 6, where the risk to be assessed is, for example, insurance loss risk, the terrorist insurance premium is determined based on one or more of property or building construction 401, property tenants 402, property information 403, building location 404, response infrastructure 405, building defense 406, attack technologies 407, the possession of the building information 408 by the hostile agent, the identity of the hostile agent 409, the possession of the building utility information 410 by the hostile agent, the available attack delivery system 411 of the hostile agent, the trained cells 412 of the hostile agent which are likely to deliver the attack, the possession of attack technologies 413 of the hostile agent, the attack infrastructure 414, the attack mode 416, the percent lost 415, the building likely to be chosen 417 by the hostile agent, the likelihood of successful attack 418, the damage effectors 420, the defense against a planned attack 421, the estimated probability of occurrence 419 of an attack, the friendly building utility 422 that may mitigate the damage, the building replacement cost 423, the estimated loss claim 424, and the gross expected loss 425. Of course, depending on the type of risk, one or more of these items may be omitted, and/or other appropriate items added.

In various exemplary embodiments, the collateral risk or collateral damage to a property due to direct attack on some other entity (such as another property, a national icon or similar entity of potential interest to a terrorist) within a radius of the property whose risk is to be assessed can be determined. For a major urban area, such as Manhattan, the likelihood of collateral risk or collateral damage to an entity is a factor that may be significant in assessing risks and/or determining the insurance premium.

In various exemplary embodiments, for a given attack mode, such as blast, entities within a nominal radius are assessed for the likelihood that they will suffer direct attack, as described above. Blast effects models are then used to assess the damage factor for an entity to be assessed or insured. The nominal radius is determined based on the specific blast attack. For example, the nominal radius of a nuclear attack is larger than that of other blast attacks. For other attack modes, appropriate effects models, such as chemical and atmospheric dispersion models, are used to assess collateral damage effects. In various exemplary embodiments, the total collateral damage factor is determined by summing over the attack modes for each entity of concern and then summing over all the entities.

In various exemplary embodiments, where the risk to be assessed is, for example, insurance loss risk, the damage rating for an entity is determined by combining the expected damage levels due to direct and indirect attacks. As discussed above, the estimated loss claim for a given event, or attack, is determined by multiplying the damage rating for the property, due to direct and indirect attack, by the value of the property.

In various exemplary embodiments, the indirect risk or indirect expected loss claim is multiplied by the probability of occurrence of attack against the entity to assess the indirect gross expected loss due to that attack mode against the entity. Where the risk to be assessed is, for example, insurance loss risk, the total indirect gross expected loss for the insured property is determined by summing over all the attack modes of each entity of concern, then summing over all the entities of concern. The total gross expected loss for the insured property is the combination of the direct attack gross expected loss and the indirect gross expected loss.

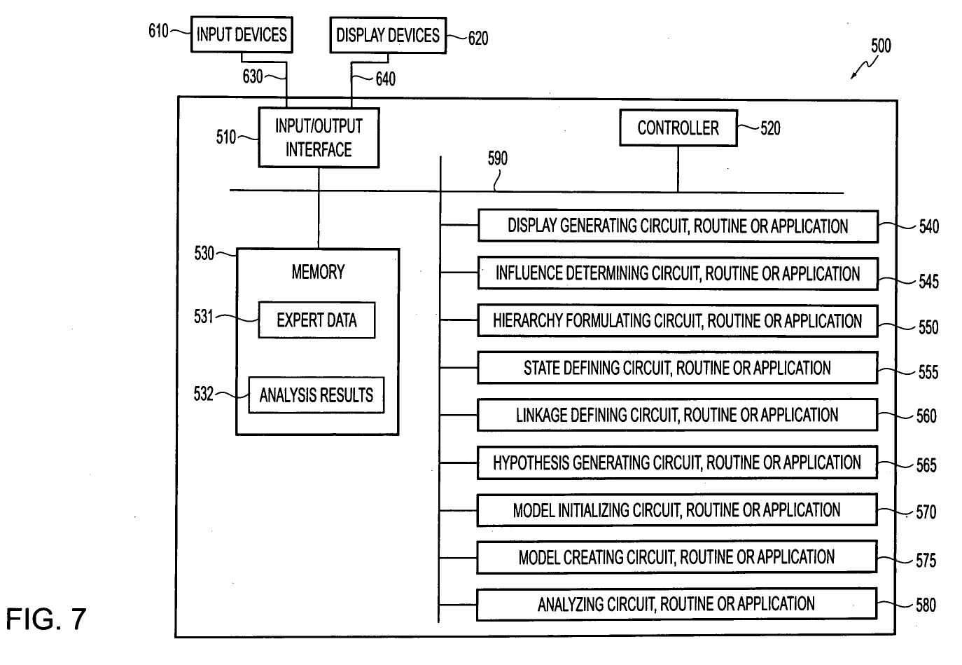

FIG. 7 is a functional block diagram of one exemplary embodiment of a threat assessment system according to this invention. As shown in FIG. 7, the risk assessment system 500 includes an input/out (I/O) interface 510, a controller 520, a memory 530, a display generating circuit, routine or application 540, an influence determining circuit, routine or application 545, a hierarchy formulating circuit, routine or application 550, a state defining circuit, routine or application 555, a linkage defining circuit, routine or application 560, a hypothesis generating circuit, routine or application 565, a model initializing circuit, routine or application 570, a model creating circuit, routine or application 575, and an analyzing circuit, routine or application 580, each interconnected by one or more controls and/or data busses and/or application programming interfaces 590.

As shown in FIG. 7, the risk assessment system 500, in various exemplary embodiments, is implemented on a programmable general-purpose computer. However, the system 500 can also be implemented on a special-purpose computer, a programmed microprocessor or micro-controller and peripheral integrated circuit elements, and ASAIC or other integrated circuits, a digital signal processor (DSP), a hardwired electronic or logic circuit, such as a discrete element circuit, a programmable logic device such as a PLD, PLA, FPGA or PAL, or the like. In general, any device capable of implementing a finite state machine that is in turn capable of implementing the flowchart shown in FIG. 1 can be used to implement the risk assessment system 500.

The input/output interface 510 interacts with the outside of the risk assessment system 500. In various exemplary embodiments, the input/output interface 510 may receive input from one or more input devices 610 connected with the input/output interface 510 via one or more links 630. The input/output interface 510 may display analysis result at one or more display devices 620 connected to the input/out interface 510 via one or more links 640. The one or more display devices 620 may be a display screen, an interactive screen or the like. The one or more input devices 610 may be a mouse, a track ball, a keyboard, a joy stick or the like. The one or more input devices 610 may also be switches or other widgets displayed on the one or more display devices 620.

As shown in FIG. 7, the memory 530 includes an expert data portion 531 and an analysis result portion 532. The expert data portion 531 stores expert data including information about terrorist groups and buildings that might be attacked by a terrorist group. The analysis result portion 532 stores analyzed results based on user input and the expert data.

In various exemplary embodiments, as discussed above, the expert data contains information regarding threat variables such as, for example, terrorist goals, delivery methods to deliver an attack, weapons to be employed, and/or attack mode to carry out an attack. In various exemplary embodiments, the expert data contains information regarding property variables such as, for example, building types, the type of location of the building, and/or tenants of the building.

In various exemplary embodiments, as discussed above, the expert data contains information regarding the influence among and/or the linkage between the threat and/or the property variables. In various exemplary embodiments, the expert data contains information regarding hypothesis used for initializing and/or creating risk assessment models. In various exemplary embodiments, the expert data is periodically and/or automatically updated with newly acquired information.

The memory 530 can be implemented using any appropriate combination of alterable, volatile, or non-volatile memory or non- alterable or fixed memory. The alterable memory, whether volatile or non-volatile, can be implemented using any one or more of static or dynamic RAM, a floppy disk and disk drive, a writeable or re-writeable optical disk and disk drive, a hard drive, flash memory or the like. Similarly, the non- alterable or fixed memory can be implemented using any one or more of ROM, PROM, EPROM, EEPROM, an optical ROM disk, such as a CD-ROM or a DVD-ROM disk and disk drive or the like.

In the exemplary embodiment of the risk assessment system 500 shown in FIG. 7, the display generating circuit, routine or application 540 generates graphical user interface elements that display the analysis results to users. The influence determining circuit, routine or application 545 determines the influence among the threat and/or property variables. The hierarchy formulating circuit, routine or application 550 formulates the structure in which the impact of one variable propagates through the nodes of other variables in the structure.

The state defining circuit, routine or application 555 defines the states of the variables. The linkage defining circuit, routine or application 560 defines how the variables are interconnected and how they respond to each other. The hypothesis generating circuit, routine or application 565 generates hypothesis regarding, for example, a threat, such as a chemical dispersion model.

The model initializing circuit, routine or application 570 initializes a prediction model and/or simulation regarding the results of an attack. The model creating circuit, routine or application 575 allows a user to update and/or generate a prediction model and/or simulation regarding the results of an attack based on, for example, information uniquely acquired by the user. The analyzing circuit, routine or application 550 analyzes to create analysis results, such as, for example, risk assessment and/or insurance risk loss, based on user input and the expert data.

In operation of the exemplary embodiment of the risk assessment system 500, the input/output interface 510, under control of the controller 520, receives inputs from the one or more input devices 610 regarding risk assessment data and/or insurance risk loss data of a property, and either stores them in the memory 530 and/or provide them directly to the influence determining circuit, routine or application 545.

The influence determining circuit, routine or application 545, based on the received inputs, determines the threat and/or property variables necessary to assess the risk of the property and the influence among the threat and/or property variables, using the expert data stored in the expert data portion 531 of the memory 530. The influence determining circuit, routine or application 545, under control of the controller 520, outputs the determined variables and the influence either to the memory 530 or directly to the hierarchy formulating circuit, routine or application 550.

The hierarchy formulating circuit, routine or application 550, under control of the controller 520, inputs the determined variables and the influence either from the memory 530 or from the influence determining circuit, routine or application 545. The hierarchy formulating circuit, routine or application 550 formulates, based on the expert data stored in the expert data portion 531 of the memory 530, the flow and/or direction in which an impact of one variable influences certain other variables that are located in the downstream in the hierarchy structure. The hierarchy formulating circuit, routine or application 550, under control of the controller 520, outputs the formulated flow/direction of impact either to the memory 530 or directly to the state defining circuit, routine or application 555.

The state defining circuit, routine or application 555, under control of the controller 520, inputs the formulated flow/direction of impact either from the memory 530 or from the hierarchy formulating circuit, routine or application 550. The state defining circuit, routine or application 555 defines the states of the determined variables, using the expert data stored in the expert data portion 531 of the memory 530 and the formulated flow/direction of impact. The state defining circuit, routine or application 555, under control of the controller 520, outputs the defined the states of the determined variables either to the memory 530 or directly to the linkage defining circuit, routine or application 560.

The linkage defining circuit, routine or application 560, under control of the controller 520, inputs the defined states either from the memory 530 or from the state defining circuit, routine or application 555. The linkage defining circuit, routine or application 560, based on the defined states and the expert data stored in the expert data portion 531 of the memory 530, defines how different aspects or sub-tasks are linked and/or integrated into a task, such as, for example, an attack or a defense, and how these aspects or sub-tasks are interconnected and how they respond to each other. The linkage defining circuit, routine or application 560, under control of the controller 520, outputs the defined linkage between the aspects either to the memory 530 or directly to the hypothesis generating circuit, routine or application 565.

The hypothesis generating circuit, routine or application 565, under control of the controller 520, inputs the linkage between the aspects either from the memory 530 or from the linkage defining circuit, routine or application 560. The hypothesis generating circuit, routine or application 565 generates hypotheses regarding a threat, such as, for example, a chemical dispersion model, based on the linkage and the expert data stored in the expert data portion 531 of the memory 530. The hypothesis generating circuit, routine or application 565, under control of the controller 520, outputs the generated hypotheses either to the memory 530 or directly to the model initializing circuit, routine or application 570. The model initializing circuit, routine or application 570, under control of the controller 520, inputs the generated hypotheses either from the memory 530 or from the hypothesis generating circuit, routine or application 565. The model initializing circuit, routine or application 570 initializes a prediction model and/or simulation regarding the results of an attack, based on the generated hypotheses and the expert data stored in the expert data portion 531 of the memory 530. The model initializing circuit, routine or application 570, under control of the controller 520, outputs the initialized model/simulation either to the memory 530 or directly to the display generating circuit, routine or application 540.

The input/output interface 510, under control of the controller 520, displays the initialized model/simulation from the display generating circuit, routine or application 540 at the one or more display devices 620, and allows a user to update the model/simulation by inputting additional information, such as, for example, information outside the hypotheses and/or information uniquely acquired by the user. The input/output interface 510, under control of the controller 520, either stores the additional information in the memory 530 or provides them directly to the model creating circuit, routine or application 575.

The model creating circuit, routine or application 575, under control of the controller 520, inputs the additional information and updates the prediction model and/or simulation, using the expert data stored in the expert data portion 531 of the memory 530. The model creating circuit, routine or application 575, under control of the controller 520, outputs the updated prediction model and/or simulation either to the memory 530 or directly to the analyzing circuit, routine or application 550 for analysis.

The analyzing circuit, routine or application 550, under control of the controller 520, executes the updated prediction model and/or simulation, generates analysis results based on the expert data stored in the expert portion 531 of the memory 530. The analyzing circuit, routine or application 550, under control of the controller 520, outputs the generated analysis results either to the memory 530 or directly to the display generating circuit, routine or application 540. The input/output interface 510, under control of the controller 520, displays the analysis results at the one or more display devices 620.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications, variations, improvements, and substantial equivalents.

What is claimed is:

1. A method for establishing an insurance premium usable to insure against risk to a property due to terrorist activities, comprising:
providing expert data, the expert data containing information regarding a possible attack from a terrorist group on the property;
determining a plurality of variables based on the provided expert data, each variable characterizes an aspect of one of the possible attack and the property;
formulating a hierarchy in which the plurality of variables are interconnected based on the provided expert data;
determining a state for each of the plurality of variables based on the formulated hierarchy and the provided expert data;
generating a model regarding the possible attack based on the determined states of the plurality of variables and the provided expert data;
assessing risks of the property under the possible attack by the terrorist group based on the generated model; and
establishing the insurance premium for the property based on the assessed risks.

2. The method according to claim 1, wherein generating the model comprises:
generating a hypothesis regarding the possible attack based on the formulated hierarchy and the provided expert data;
initializing the model based on the generated hypothesis and the provided expert data; and
updating the model based on information outside the generated hypothesis and the provided expert data.

3. The method according to claim 1, wherein determining a state for each of the plurality of variables comprises determining a linkage between a first variable and a second variable.

4. The method according to claim 1, wherein providing expert data comprises providing information regarding a goal of the terrorist group.

5. The method according to claim 1, wherein providing expert data comprises providing information regarding an attack delivery method of the terrorist group.

6. The method according to claim 1, wherein providing expert data comprises providing information regarding a weapon likely to be deployed by the terrorist group against the property.

7. The method according to claim 1, wherein providing expert data comprises providing information regarding a mode of the terrorist group to carry out the possible attack against the property.

8. A computer storage medium having executable software code for establishing an insurance premium usable to insure against risk to a property due to terrorist activities, the executable software code including:
instructions for providing expert data, the expert data containing information regarding a possible attack from a terrorist group on the property;
instructions for determining a plurality of variables based on the provided expert data, each variable characterizes an aspect of one of the possible attack and the property;
instructions for formulating a hierarchy in which the plurality of variables are interconnected based on the provided expert data;
instructions for determining a state for each of the plurality of variables based on the formulated hierarchy and the provided expert data;
instructions for generating a model regarding the possible attack based on the determined states of the plurality of variables and the provided expert data;
instructions for assessing risks of the property under the possible attack by the terrorist group based on the generated model; and
instructions for establishing the insurance premium for the property based on the assessed risks.

9. The computer storage medium of claim 8, wherein the instructions for generating the model comprises:
instructions for generating a hypothesis regarding the possible attack based on the formulated hierarchy and the provided expert data;
instructions for initializing the model based on the generated hypothesis and the provided expert data; and
instructions for updating the model based on information outside the generated hypothesis and the provided expert data.

10. The computer storage medium of claim 8, wherein the instructions for determining a state for each of the plurality of variables comprise instructions for determining a linkage between a first variable and a second variable.

11. The computer storage medium of claim 8, wherein the instructions for providing expert data comprise instructions for providing information regarding a goal of the terrorist group.

12. The computer storage medium of claim 8, wherein the instructions for providing expert data comprise instructions for providing information regarding an attack delivery method of the terrorist group.

13. The computer storage medium of claim 8, wherein the instructions for providing expert data comprise instructions for providing information regarding a weapon likely to be deployed by the terrorist group against the property.

14. The computer storage medium of claim 8, wherein the instructions for providing expert data comprise instructions for providing information regarding a mode of the terrorist group to carry out the possible attack against the property.

15. A system for establishing an insurance premium usable to insure against risks to a property due to terrorist activities, comprising:
a database storing expert data, the expert data containing information regarding a possible attack from a terrorist group on the property;
an influence determining circuit, routine or application that determines a plurality of variables based on the provided expert data, each variable characterizes an aspect of one of the possible attack and the property;
a hierarchy formulating circuit, routine or application that formulates a hierarchy in which the plurality of variables are interconnected based on the provided expert data;
a state defining circuit, routine or application that determines a state for each of the plurality of variables based on the formulated hierarchy and the provided expert data;
a model creating circuit, routine or application that generates a model regarding the possible attack based on the determined states of the plurality of variables and the provided expert data;
an analyzing circuit, routine or application that establishes the insurance premium for the property under the possible attack by the terrorist group based on the generated model; and
a display generating circuit, routine or application that displays analyzed results.

16. The system of claim 15, further comprising:
a hypothesis generating circuit, routine or application that generates a hypothesis regarding the possible attack based on the formulated hierarchy and the provided expert data; and
a model initializing circuit, routine or application that initializes the model based on the generated hypothesis and the provided expert data,
wherein the model creating circuit, routine or application updates the model based on information outside the generated hypothesis and the provided expert data.

17. The system of claim 15, further comprising:
a linkage defining circuit, routine or application that determines a linkage between a first variable and a second variable.

18. The system of claim 15, wherein the expert data contains information regarding a goal of the terrorist group.

19. The system of claim 15, wherein the expert data contains information regarding an attack delivery method of the terrorist group.

20. The system of claim 15, wherein the expert data contains information regarding a weapon likely to be deployed by the terrorist group against the property.

21. The system of claim 15, wherein the expert data contains information regarding a mode of the terrorist group to carry out the possible attack against the property.
